(19) United States
(12) Patent Application Publication
(10) Pub. No.: US 2002/0124946 A1
(43) Pub. Date: Sep. 12, 2002

(54) Process and machining facility for producing continuous veneer laminate plates

(75) Inventor: Matthias Graf, Eppingen (DE)

Correspondence Address: George E. Quillin, Foley & Lardner, Washington Harbour, 3000 K Street, N.W., Suite 500, Washington, DC, 20007-5143, US

(73) Assignee: Maschinenfabrik J. Dieffenbacher GmbH & Co.

(21) Appl. No.: 10/052,569

(22) Filed: Jan. 23, 2002

Related U.S. Application Data
(60) Provisional application No. 60/263,187, filed on Jan. 23, 2001.

(51) Int. Cl. B29C 47/00

(52) U.S. Cl. 156/246; 156/268; 156/250

(57) ABSTRACT

A process for producing continuous veneer laminate panels by gluing and pressing in a hot press overly wide veneer sheets in several layers of veneer sheet sections combined one on top of another or one after another. The veneer sheet section combined with the overly wide veneer sheets is provided before entering into the hot press with steam exhaust joints via one or several longitudinal cuts and, in this way, is divided into two or several veneer sheet sections which are variable in their width, and the longitudinal cuts take place in correspondence to the several predetermined partitioning widths of the finished veneer laminate panels.

This application claims the benefit of U.S. Provisional Application No. 60/263,187, filed Jan. 23, 2001.

### BACKGROUND OF THE INVENTION

The invention concerns a process for producing continuous veneer laminate panels and a machining facility for carrying out the process.

In the production of veneer laminate panels, a phenol formaldehyde adhesive is usually used. The veneers or the veneer panels are fed to the process with a moisture content (“humidity”) of about 6-8% and the adhesive mixture is applied thereon via an adhesive application machine. Into the adhesive mixture are added, aside from the actual adhesive substances, inter alia, also about 50% water to maintain a viscosity suitable for the application process. With reference to the dry weight of the veneers, the veneer sheet section is provided via the adhesive with another approximately 5-7% humidity. The adhesive is bonded via a polycondensation in the continuously working press or in a multi-daylight press under the effects of pressure and heat. The temperature required to initiate this chemical reaction amounts to at least 100° C. In the practice, 110°-120° C. are usually reached in the center of the panel at the end of the process. At this temperature, the water content contained in the veneer sheet section converts into steam. This steam is, in correspondence to the temperature, under an equivalent steam pressure. At the end of the pressing path, the bonding force of the adhesive must be stronger than the dominant steam pressure, since otherwise the increased steam pressure leads to blistering in the cover layers or center layers of the panel.

To reduce the danger of blistering, a ventilation stage is initiated shortly before the end of the pressing procedure. For this purpose, the pressure force is strongly reduced so that the panel is still sufficiently supported but it is easier for the contained steam to escape through the panel edges via the permeability of the wood veneers. As one can imagine, there is a danger herein of a pressure gradient from the panel center toward the two panel edges. The steam can escape easier at the areas near the edges and less so at the panel center. For this reason, the blistering danger in the center of the panel is always greatest.

In the production of overly wide veneer sheets, with production widths of 2500 to 3600 mm with respect to the standard production widths of typically 1200 to 1400 mm, a ventilation is considerably more difficult. To still prevent the formation of blisters in these overly wide processes, the pressing times are extended by 3-5%. In this way, the adhesive can be bonded to a greater extent and can therefore compensate for the higher steam pressures. This procedure, however, increases the investment costs when one presupposes that a specific production performance must be achieved.

### SUMMARY OF THE INVENTION

One object of the invention is to provide a method with which the escape of the contained steam in overly wide veneer sheet sections is considerably facilitated and a machining facility with which the process can be realized.

The object is attained in that the veneer sheet section combined with overly wide veneer sheets is provided with steam exhaust gaps via one or several longitudinal cuts before entering the hot press and, in this way, is divided into two or several veneer sheet sections which are variable in width and in which the longitudinal cuts take place in correspondence with the multiple predetermined partitioning widths of the finished veneer laminate panels.

The machining facility according to a first exemplary embodiment is characterized in that, ahead of the hot press, one or several center section cutting saw devices are arranged in a frame and can be variably adjustable as to their position within the width of the veneer sheet section, while the veneer sheet section can be partitioned in the area of the center section cutting saw devices which can be lifted from the loading belt by means of a ridge reaching over the width and can be fully cut into displaceable wedges of this ridge by cutting saws and can be partitioned into two or several individual veneer sheet sections with variable widths.

The machining facility according to a second exemplary embodiment consists in that one or several center section cutting saw devices, which are variably adjustable as to their position within the width of the veneer sheet section between a feeding belt and a delivery belt, are provided in a frame ahead of the hot press, a dip roller is arranged under each cutting saw, and hold-down rolls are arranged on both sides of the cutting saws as well as over and under the veneer sheet section, wherein the veneer sheet section is full cut via the cutting saws and can be partitioned into two or several individual veneer sheet sections with variable widths.

It is advantageous that the steam can escape, in this way, to the ventilation zone at both panel edges of each of the individual veneer sheet sections via the steam exhaust gaps, for example, in a continuous working hot press. The steam which escapes in the direction of the partition cuts is guided along the partition cut in the direction of the runout of the press and can be collected and discharged there by means of suction hoods. The cutting saws are displaceably arranged in their position over the panel width. The position of the saws can be selected in dependence upon which end production widths are to be cut from the finished veneer laminate panel, so that they can be in a position at which, when cutting in, partition cuts are anyway necessary and, in this way, no additional loss of material is generated.

When carrying out the partition cuts or the partition joints it must be prevented that cutting shavings arrive into the adhesive joints of the veneer sheet sections. Hold-down rolls or a hold-down belt which push down on the veneer sheet section can be used for this purpose in the area to be cut and, in this way, hold the adhesive joints closed. Another embodiment consists in carrying out the partition cut with a water jet cutting device or a laser cutting head.

### BRIEF DESCRIPTION OF THE DRAWINGS

Other advantageous measures and embodiments of the object of the invention become apparent from the dependent claims and the following description of the drawings, wherein:

FIG. 1 shows the machining facility according to the invention in side view for carrying out the process according to the invention;

FIG. 2 shows a front view of a section A-A according to FIG. 1 of the center section cutting saw device according to a first exemplary embodiment;

FIG. 3 shows a second section A-A according to FIG. 1 and a front view of the center section cutting saw device according to the second embodiment;

FIG. 4 shows a side view of a section B-B of the second exemplary embodiment according to FIG. 3;

FIG. 5 shows the steam pressure over the panel width with and without steam exhaust joint in a diagram with hot press; and

FIG. 6 shows the center section cutting saw device in side view according to a section C-C of FIG. 2.

### DETAILED DESCRIPTION OF THE PREFERRED EMBODIMENTS

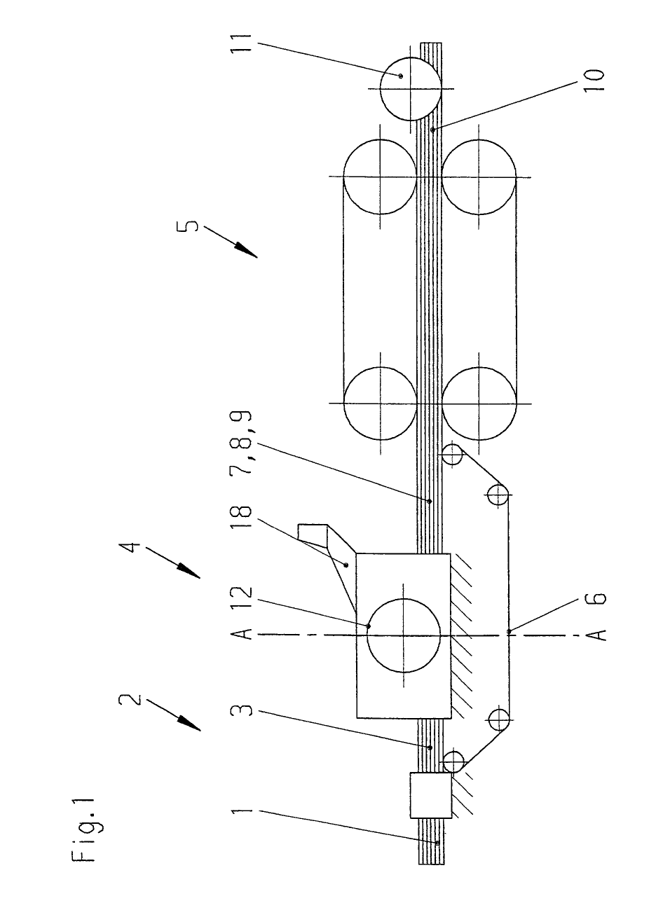

FIG. 1 shows in an overall overview the machining facility according to the invention for carrying out the process according to the invention.

The overly wide veneer sheets 1 run with a high speed through several devices (not shown) and then into the veneer sheet depositing device 2. Before combining a veneer sheet section 3 in the veneer sheet depositing device 2 and introducing the same into the hot press, in the example a continuously working press 5, four feet wide veneer sheets are glued or connected with a sewing seam in a sewing machine (not shown) to an overly wide veneer sheet 1 and fed to the veneer sheet depositing device 2.

The loading, the superposed combining, and the sequential joining of the overly wide veneer sheets 1 in the veneer sheet depositing device 2 into a veneer sheet section 3 is based on the state of the art according to German patent publication 196 27 024 and is also the object of German patent applications 198 35 933 and 199 16 041.

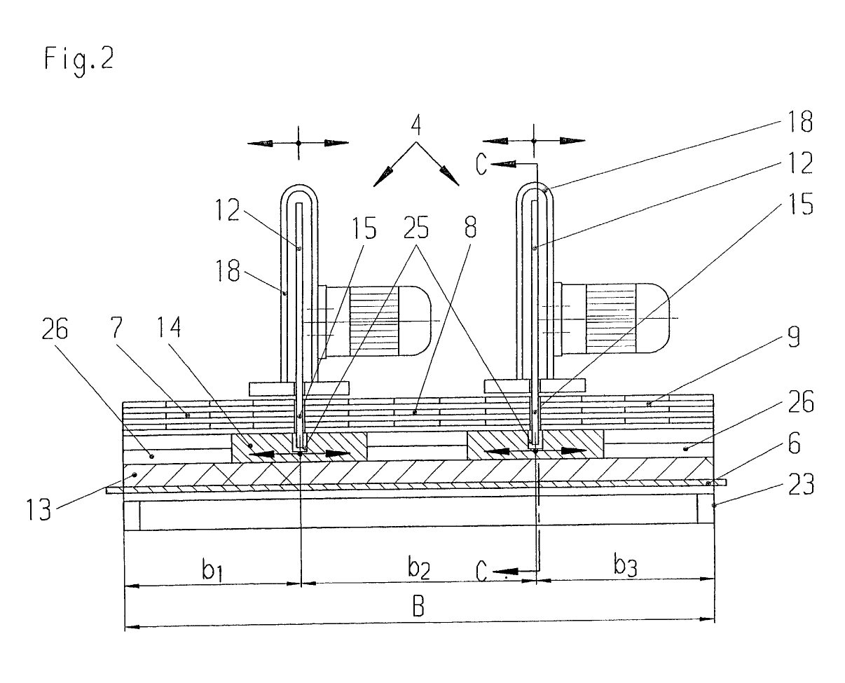

According to the first exemplary embodiment of the machining facility according to FIG. 2, the loading belt 6 takes over the veneer sheet section 3 from the veneer sheet depositing device 2 and leads the same through one or several center section cutting saw devices 4. Herein, one or several cutting saws 12 cut cutting joints 15 from the veneer sheet section 3 to steam exhaust gaps so that the steam that is generated during gluing and pressing in the hot press can escape on both side edges of each of the individual veneer sheet sections 7, 8, and 9. So that the cutting of the individual sections is made possible, the continuous veneer sheet section 3 is lifted by means of a ridge 13 arranged transversely over the loading belt 6 during the forward movement. In the center of the ridge 13 is accommodated a slit 26 in which a wedge 14 with cutout 25 is displaceably arranged for each cutting saw 12 to form equally or differently wide individual veneer sheet sections 7, 8, and 9 from the veneer sheet section 3. In this way, the cutting saws 12 can be used ahead of the hot press 5 at the same time as partitioning saws.

The veneer sheet section width B must therefore not necessarily be divided into two or several equally wide pieces having the width B. In this way, the partition cut can be placed in an advantageous manner at the locations wherein a partition cut would have taken place anyway in the final production. If the number of end products which are cut from the entire finished panel 10 cannot be divided by the number of section panels, then the partial widths b1, b2, etc. (that is, individual veneer sheet section width) can be different.

The separated individual veneer sheet sections 7, 8, and 9 are introduced, after the center section cutting saw device 4, from the loading belt 6 into the continuously working press 5 and are here glued into several continuous veneer laminate panels 10 and compressed and then, if necessary, brought to their final form via seaming and cutting saws 11. FIG. 2 shows how the cutting joints 15 are carried out in the veneer sheet section 3 of width B. The individual veneer sheet sections 7, 8, and 9 with the widths b1, b2, and b3 are produced in dependence upon the position of the cutting saws 12 to each other with the distance t together with the wedges 14. Therefore, cutouts 25 for the cutting saws 12 are accommodated in the wedges 14.

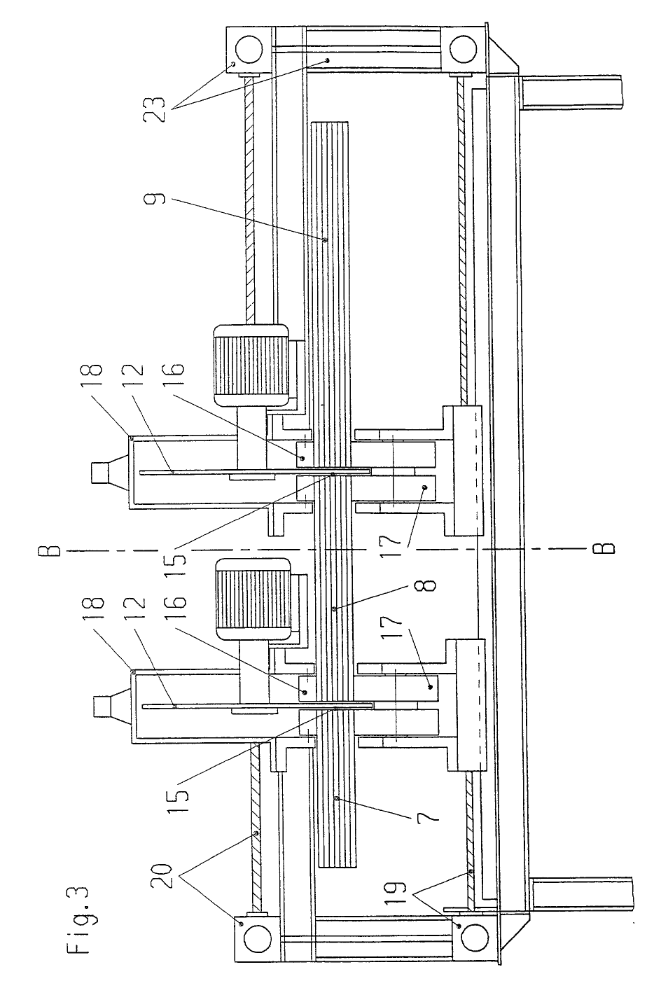

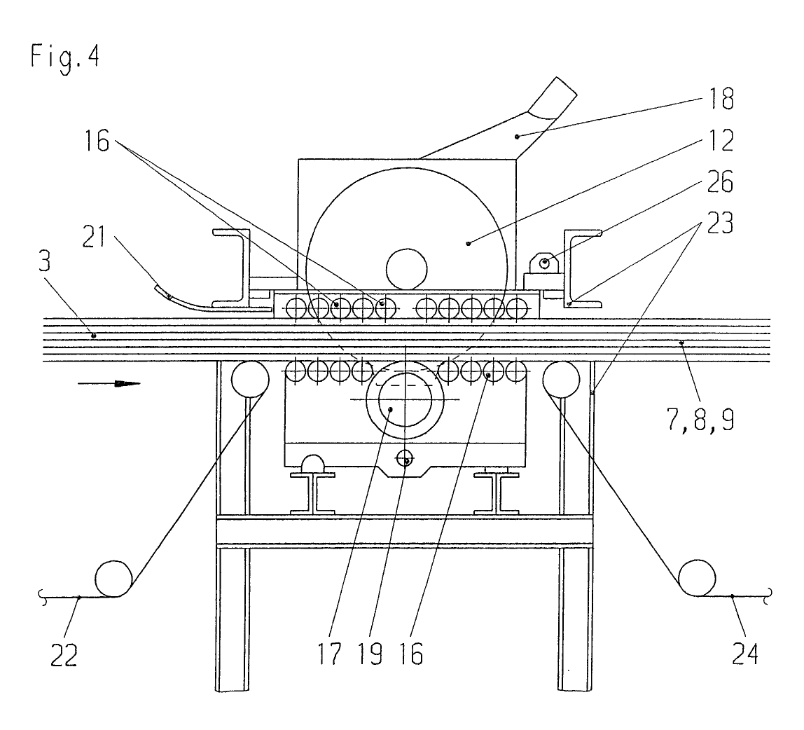

According to FIGS. 3 and 4, according to the second exemplary embodiment, two center section cutting saw devices 4 with hold-down rolls 16 are arranged in the frame 23 on the veneer sheet section 3 in such a way that the cutting saws 12 cut against dip rollers 17 with hold-down rolls 16 under the veneer sheet section 3. The hold-down rolls 48, aside from serving to improve the cut quality, also prevent cutting shavings from arriving into the adhesive joints of the veneer sheet section 3 during sawing. Suction hoods 18 for removing the cutting shavings are arranged over the cutting saws 12. The center section cutting saw devices 4 are synchronously displaceable within the veneer sheet section width B with the corresponding dip rolls 17 via control gears 19 below and control gears 20 above, so that individual veneer sheet sections 7, 8, and 9 can be cut with optional widths b1, b2 and b3.

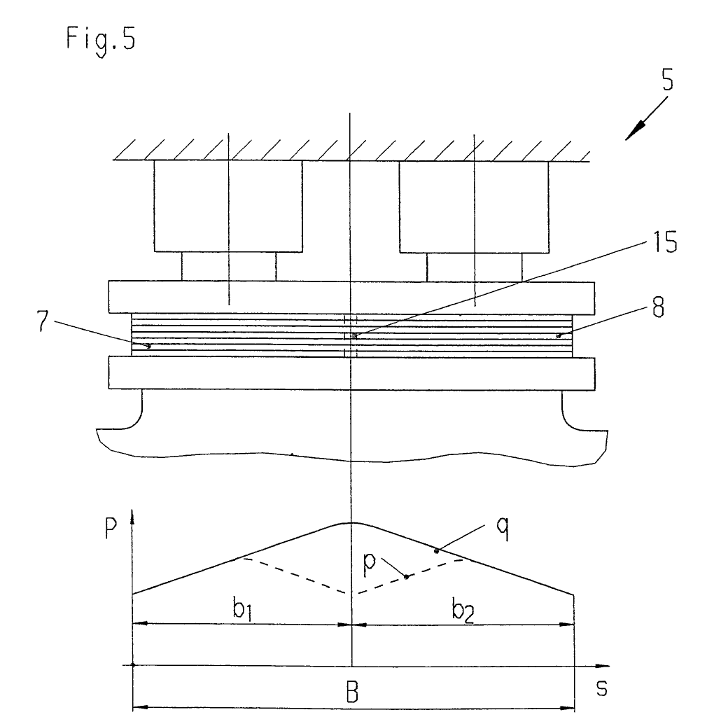

In the area of the frame 23, because of the selected technology, no supporting loading belt 6 can guide the veneer sheet section 3. For this purpose, ahead of the frame 23 is arranged the supply belt 22 and behind the frame 23 is arranged the delivery belt 24. On the frame 23 is initially purposefully arranged an inlet shoe 21 as insertion aid for the veneer sheet section 3. In FIG. 5, in a front view of the hot press 5 and veneer laminate panel 10 over the width B, the steam pressure with cutting joint is indicated by p, on the one hand, and the steam pressure without steam exhaust joint or without a cutting joint 15 is indicated with q. From this can be seen that, with the process according to the invention and the machining facility according to the invention, the steam pressure can be considerably reduced within the finished veneer laminate panel 10.

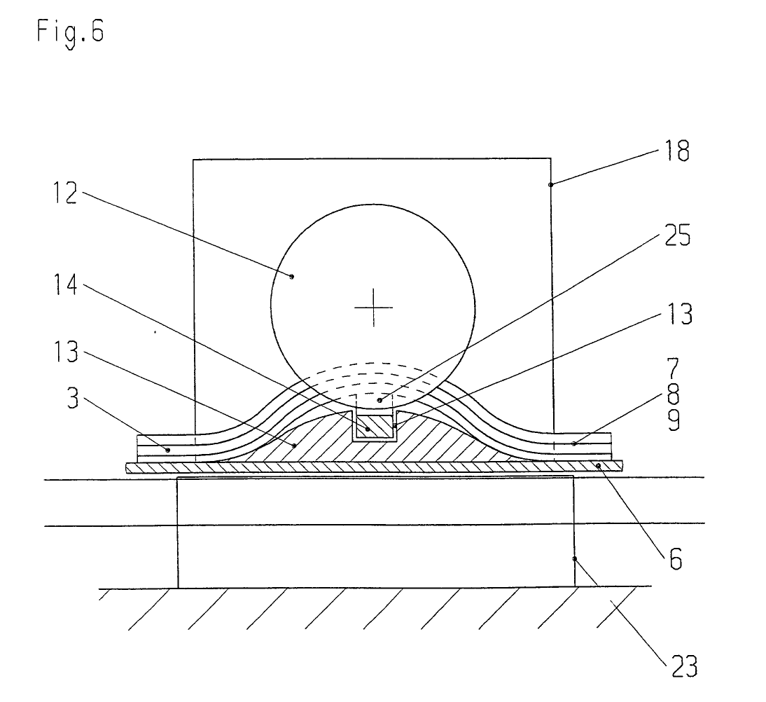

FIG. 6 shows in section A-A and in side view the bridging of the veneer sheet section 26 via the ridge 37. In this way, the cutting saw 39 cuts the veneer sheet section 28, in the cutout 52 of the wedge 38, into three individual veneer sheet sections 40, 41, 42.

Accordingly, in one preferred embodiment, the invention includes a process for producing continuous veneer laminate panels by gluing and pressing in a hot press overly wide veneer sheets in several layers of veneer sheet sections combined one on top of another or one after another, characterized in that the veneer sheet section combined with the overly wide veneer sheets is provided before entering into the hot press with steam exhaust joints via one or several longitudinal cuts and, in this way, is divided into two or several veneer sheet sections which are variable in their width, and in that the longitudinal cuts take place in correspondence to the several predetermined partitioning widths of the finished veneer laminate panels.

According to another preferred embodiment, the invention includes a process according to the definition in the paragraph above, characterized in that the partition cuts in the veneer sheet section are carried out via a water jet device or a laser cutting head.

According to another preferred embodiment, the invention includes a machining facility for carrying out the process according to the definition in the second paragraph above, including a veneer sheet depositing device for depositing an overly wide continuous veneer sheet section and a discontinuously or continuously working hot press, characterized in that, ahead of the hot press (5), one or several center section cutting saw devices (4) which are variably adjustable as to their position within the width (B) of the veneer sheet section (3), are arranged in a frame (23), wherein the veneer sheet section (3) can be lifted from the loading belt (6) in the area of the center section cutting saw device (4) via a ridge (13), which reaches over the width (B), and can be fully cut into displaceable wedges (14) of this ridge (13) by cutting saws (12) and can be partitioned into two or several individual veneer sheet sections (7, 8, 9) with variable widths (b1, b2, b3).

According to another preferred embodiment, the invention includes a machining facility for carrying out the process according to the definition in the third paragraph above, including a veneer sheet depositing device for depositing an overly wide continuous veneer sheet section and a discontinuous or continuous working hot press, characterized in that, ahead of the hot press (5), one or several center section cutting saw devices (3), which are variably adjustable as to their position within the width (B) of the veneer sheet section (3) are arranged between a feeding belt (22) and a delivery belt (24) provided in a frame (23), a dip roller (17) is arranged under each cutting saw (12), and hold-down rolls (16) are arranged on both sides of the cutting saws (12) as well as over and under the veneer sheet section (3), wherein the veneer sheet section (3) is fully cut via the cutting saws (12) and can be partitioned into two or several individual veneer sheet sections (7, 8, 9) with variable widths (b1, b2, b3).

Additional advantages and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

The corresponding German parent application 199 52 269.3 filed Oct. 29, 1999, is hereby incorporated by reference.

What is claimed is:

1. A method for producing veneer laminate, comprising the steps of:
layering a plurality of veneer sheets one above the other and one behind the other to form a veneer sheet section;
providing the veneer sheet section with at least one steam exhaust joint; and
pressing the veneer sheet section in a hot press.

2. The method according to claim 1, wherein the at least one steam exhaust joint comprises a longitudinal cut whereby the veneer sheet section is divided into a plurality of veneer sheet sections of predetermined widths.

3. The method of claim 2, wherein the longitudinal cut is made by either a water jet device or a laser cutting head.

4. The method of claim 1, further comprising the step of interposing an adhesive between a plurality of the veneer sheets.

5. An apparatus for producing veneer laminate, wherein a veneer sheet section is provided with a steam exhaust joint before the veneer sheet section is pressed by a hot press, comprising:
a veneer sheet section depositing device for depositing a veneer sheet section onto a transfer belt;
at least one cutting saw wherein the at least one cutting saw is movable relative to a width of the veneer sheet section; and
at least one ridge substantially spanning the width of the transfer belt wherein the veneer sheet section is raised above the transfer belt by the at least one ridge in the area of the at least one cutting saw.

6. The apparatus as claimed in claim 5, wherein the at least one ridge includes an opening for receiving a displaceable wedge wherein a slot in the displaceable wedge accommodates the at least one cutting saw.

7. An apparatus for producing veneer laminate, wherein a veneer sheet section is provided with a steam exhaust joint before the veneer sheet section is pressed by a hot press, comprising:
a belt system for transferring the veneer sheet section, the belt system including a feeding belt and a delivery belt;
at least one cutting saw arranged between the feeding belt and the delivery belt, wherein the at least one cutting saw is moveable relative to a width of the veneer sheet section;
a dip roller arranged under the at least one cutting saw;
a plurality of first hold-down rolls arranged laterally to the cutting saws, wherein the veneer sheet section passes under the first hold-down rolls; and
a plurality of second hold-down rolls arranged laterally to the cutting saws, wherein the veneer section passes over the second hold-down rolls.

8. An apparatus as claimed in claim 7, wherein the dip roller is moveable relative to the width of the veneer sheet section.
